(19) United States
(12) Patent Application Publication
(10) Pub. No.: US 2015/0091930 A1
(43) Pub. Date: Apr. 2, 2015

(54) MONITORING SUBJECT DISPLAYING DEVICE AND METHOD, AND MONITORING SUBJECT DISPLAYING COMPUTER PROGRAM

(71) Applicant: AZBIL CORPORATION, Tokyo (JP)

(72) Inventor: Toshifumi YASUHARA, Tokyo (JP)

(73) Assignee: AZBIL CORPORATION, Tokyo (JP)

(21) Appl. No.: 14/497,669

(22) Filed: Sep. 26, 2014

(30) Foreign Application Priority Data
Sep. 27, 2013 (JP) 2013-201070

(51) Int. Cl. G09G 5/37; G09G 5/30

(52) U.S. Cl. CPC G09G 5/37; G09G 5/30; G09G 2320/10; G09G 2354/00
USPC 345/581

(57) ABSTRACT

A monitoring subject displaying device includes: a storing portion that stores an object, being an object for which a correspondence to the monitoring subject is defined, including a property that describes a status of the object, and a behavior for calculating a value for the property based on a value of a parameter of the monitoring subject; a property updating portion that updates, to the value calculated in accordance with the behavior, the value of the property of the object stored in the object storing portion; a property update history storing portion that stores a history of property updating by the property updating portion; and a displaying portion that displays, on a displaying device, the object that is stored in the object storing portion, using a historic value for the property, stored in the property update history storing portion.

### CROSS REFERENCE TO RELATED APPLICATION

This application claims priority under 35 U.S.C. §119 to Japanese Patent Application No. 2013-201070, filed on Sep. 27, 2013, the entire content of which being hereby incorporated herein by reference.

### FIELD OF TECHNOLOGY

The present invention relates to a monitoring subject displaying device and a method, for displaying, on a displaying device, a status that is subject to monitoring, and, more specifically, relates to a monitoring subject graphic display in an instrument monitoring device.

### BACKGROUND

In a DCS (Distributed Control System) for monitoring and controlling a plant, or the like, the plurality of instruments that structure the plant, or the like, is expressed graphically on a display screen, and the process data, such as measurement values and setting values, and the like, that are subject to monitoring and control are visualized through a text display or graphic display as the human-machine interface (HMI). See, for example, Japanese Unexamined Patent Application Publication No. 2012-194765. In applications that are run on personal computers (PCs), there are those wherein customized graphic screens are displayed for each individual user, to perform operations for changing the display and setting values for the process data.

Typically, the graphics screen, as described above, is generated using an editing application. The editing application is provided with graphic parts (“objects”) such as text objects for displaying character strings, bar objects for displaying bar graphs, and the like. Here each graphic part has its own characteristic properties. For example, a text object has the properties required for displaying objects, such as text, text color, text size, and the like.

For example, graphic parts that are defined as corresponding to the monitoring subject can be located in arbitrary locations on the editing screen, and the graphics parts can be displayed as a static screen by setting the default values for the properties.

Moreover, when changing the display in response to a change in a measurement value, it is possible to display as video, by setting up “behaviors” for the graphic parts.

Each individual user is able to create a display screen, to serve as an HMI, through performing editing on each required screen such as positioning the graphic parts, setting up the default values for the properties, editing the behavior definitions, and the like.

FIG. 11 and FIG. 12 will be referenced below to explain the structure of the device for displaying that which is to be monitored, using a display screen that is generated through disposing the graphic parts, described above, and to explain the display method thereof.

A conventional monitoring subject displaying device comprises screen data 100 that stores objects for which associations with monitoring subjects are defined, including properties which define the status of the object, and behaviors calculated based on the property values and the values for the parameters of the monitoring subject; a data acquiring portion 20 for collecting values of parameters of the monitoring subject; a data comparing portion 30 for detecting a change in a value of a parameter; an object data updating portion 40 for updating a value of a property based on a value that has been changed in a bound parameter through executing the behavior of the object, referencing the parameter for which the value has been updated; and a displaying portion 50 for displaying a screen on the displaying device 2, referencing the screen data 100.

Here the screen data 100 is data including a list of graphic parts that structure a single screen (an object list) 101′, a list of parameters for data collection within the display of the screen (a data collection list) 102, and a list of reference relationships of the graphic parts that are stored in the object list 101′ and the parameters of the data collection list 102, and of the reference relationships between the graphics parts stored in the object list 101′ (referenced object list) 103. This screen data file is stored, as a screen file, in a storing device such as a hard disk drive (HDD), or the like.

At run-time, the screen file is loaded, and a display screen wherein the graphic parts of the object list 101′ are disposed on the screen with the default values of the properties, is displayed on the displaying device 2. Thereafter, the display screen is updated through a procedure such as the following.

First the data acquiring portion 20 references the data collection list 102, and collects, from the data server 4, with each specific period, the values of the parameters that are bound to the graphic parts (objects) that structure the display screen, and at that time, the existing data 121 that is stored in the prescribed region of the storing device is updated (FIG. 12: S1). The current data 121 is compared to the previous data 122 by the data comparing portion 30, and if there has been a change in the parameter value, then the referenced object list 103 is referenced, and a list of the objects that are bound to the parameters wherein the values have changed (a changed object list 123) is generated, and stored in the prescribed area of the storing device (S2).

The object data updating portion 40 references the changed object list 123 and executes a behavior, defined in advance by a user, on an object (Obj1) that is bound to the parameter for which the value has changed, and changes the value of the property of the object (Obj1) in accordance with that behavior. Specifically, the first object of the changed object list is retrieved (S3), the behavior of that object is executed (S4), the property of the object is updated (S6), and if there are more objects on the changed object list (S7: YES), then the retrieval of the subsequent object (S11), the execution of the behavior of that object (S4), and the updating of the property (S6) are executed for all of the objects included in the changed object list. Once the execution of the behavior (S4) and the updating of the property (S6) for all of the objects included in the changed object list has been completed (S7: NO), then the displaying portion 50 updates the screen using the values of the properties of the updated objects (S10).

The monitoring subject displaying device, which has a display screen wherein the monitoring subjects are expressed graphically using the graphic parts, as described above, is that which displays the current statuses of the monitoring subjects, and a screen that is separate from the display screen that is described above, such as a trend screen, is used to show changes in values of parameters in order to check historic statuses.

In contrast, as a method for displaying a historic status using a display screen for expressing graphically a plurality of instruments that structure a plant, or the like, that is a monitoring subject, one may consider making a video recording of a display screen, or saving the parameter values, and performing the screen display based on the historic values that have been saved (an event history). See, for example, Japanese Unexamined Patent Application Publication Nos. 2003-029826 and H9-016249.

However, when a trend screen is used to display the historic status of a monitoring subject, it is necessary to display a separate display screen from the display screen for expressing graphically, and it is not possible to reproduce the change in status of the monitoring subject using the original graphic display screen. Furthermore, if, for example, the current status of the monitoring subject is displayed on the display screen for the graphical expression of the monitoring subject, then in order to check values of parameters before and after an alarm is produced, it is necessary to display a trend screen that includes, from the large number of parameters that exist, those parameters that caused the alarm.

Moreover, the method wherein a video recording of the display screen that expresses the monitoring subject graphically is made also is unable to reproduce the display of a change in the status of the monitoring subject using the original graphic display screen, and there is a problem in that there is a vast amount of data that is recorded in order to record the video data.

Moreover, in a method wherein the change in status of the monitoring subject is reproduced and displayed based on historic values of parameters (an event history), not only is it not possible to reproduce the display of the change in the status of the monitoring subject using the original graphic display screen, but also it is necessary to save the historic values of the related parameters (the event history), so not only is it necessary to save a vast amount of data, but also it is necessary to calculate the values of the properties for the graphic parts (objects) continuously based on the values of the parameters, thus causing an increase in the calculation overhead. Furthermore, in a screen display based on the event history, it is necessary to communicate the behavior in order to reflect the historic events onto the screen display, and thus even if the values of the parameters in the data collection list 102 are identical, they are not necessarily displayed identically on the screen, and thus a playback screen that is able to rewind, from the present toward the past, changes in status of the monitoring subject is difficult.

Given this, an aspect of the present invention is that of displaying a historic status of a monitoring subject using a display screen that is structured through graphic parts (objects), without using a vast amount of data such as video data or an event history. Moreover, another aspect of the present invention is to playback, on a screen, changes in historic statuses of the monitoring subject through rewinding from the present to a historic status, or fast-forwarding the display screen from a historic status to the present.

### SUMMARY

In order to achieve such aspects set forth above, the monitoring subject displaying device according to the present invention is a monitoring subject displaying device including: a storing portion that stores an object, being an object for which a correspondence to the monitoring subject is defined, including a property that describes a status of the object, and a behavior for calculating a value for the property based on a value of a parameter of the monitoring subject; a property updating portion that updates, to the value calculated in accordance with the behavior, the value of the property of the object stored in the object storing portion; a property update history storing portion that stores a history of property updating by the property updating portion; and a displaying portion that displays, on a displaying device, the object that is stored in the object storing portion, using a historic value for the property, stored in the property update history storing portion.

In the monitoring subject displaying device according to the present invention, the property update history storing portion maybe structured from a property update history table for storing a time at which a value of a property was changed, and the value to which the property was changed, in relation to each other.

The monitoring subject displaying device according to the present invention may further includes: a display controlling portion that switches between a current mode for displaying the object using a current value for the property, and a historic mode for displaying the object using a historic value for the property, stored in the property update history storing portion; and the displaying portion, in the current mode, may display the object on the displaying device using the current value for the property, and in the historic mode, may display the object on the displaying device using a historic value for the property, stored in the property update history storing portion.

In the monitoring subject displaying device according to the present invention, when a plurality of historic values for the property, stored in the property update history storing portion, form a time series, the object may be displayed sequentially on the displaying device using historic values following the time series.

A monitoring subject displaying method according to the present invention includes: a step for storing, in a storing portion, an object, being an object for which a correspondence to the monitoring subject is defined, including a property that describes a status of the object, and a behavior for calculating a value for the property based on a value of a parameter of the monitoring subject; a step wherein a property updating portion updates, to the value calculated in accordance with the behavior, the value of the property of the object stored in the object storing portion; a step for recording, in a property update history storing portion, a history of property updating by the property updating portion; and a step wherein a displaying portion displays, on a displaying device, the object that is stored in the object storing portion, using a historic value for the property, stored in the property update history storing portion.

A non-transitory computer-readable medium embodies a computer program that causes a computer to function as a monitoring subject displaying device including: a storing portion that stores an object, being an object for which a correspondence to the monitoring subject is defined, including a property that describes a status of the object, and a behavior for calculating a value for the property based on a value of a parameter of the monitoring subject; a property updating portion that updates, to the value calculated in accordance with the behavior, the value of the property of the object stored in the object storing portion; a property update history storing portion that stores a history of property updating by the property updating portion; and a displaying portion that displays, on a displaying device, the object that is stored in the object storing portion, using a historic value for the property, stored in the property update history storing portion.

Given the present invention, a history of updates to properties is stored in a property update history storing portion, and the objects are displayed using the values of the properties that are stored in the property update history storing portion, thus enabling displaying of historic statuses of the monitoring subject using the display screen that is structured from the graphic parts (objects) without using a large amount of data such as video data or an event history, or the like.

Moreover, in the present invention it is possible to playback historic status changes of the monitoring subject, using a display screen that is structured from graphic parts (objects), such as rewinding the display screen from the present to a historic status, through displaying objects using values of properties stored in the property update history storing portion.

### BRIEF DESCRIPTIONS OF THE DRAWINGS

FIG. 1 is a diagram illustrating an overview of a DCS that includes a monitoring subject displaying device according to an example according to the present invention.

FIG. 2 is a diagram illustrating an example of a hardware structure of a monitoring displaying device according to the example according to the present invention.

FIG. 3 is a diagram for explaining a method for generating a display screen on the monitoring subject displaying device according to the example according to the present invention.

FIG. 4 is a diagram illustrating an example of a display screen of a monitoring subject displaying device according to the example according to the present invention.

FIG. 5 is a diagram illustrating an example of a structure of a monitoring subject displaying device according to the example according to the present invention.

FIG. 6 is a diagram illustrating an example of a property update history table of a monitoring subject displaying device according to the example according to the present invention.

FIG. 7 is a flowchart for explaining the operation of the monitoring subject displaying device according to the example according to the present invention.

FIG. 8 is a flowchart for explaining the operation of the monitoring subject displaying device according to the example according to the present invention.

FIG. 9 is a flowchart for explaining the operation of the monitoring subject displaying device according to the example according to the present invention.

FIG. 10 is a flowchart for explaining the operation of the monitoring subject displaying device according to the example according to the present invention.

FIG. 11 is a diagram illustrating one example configuration of a conventional monitoring subject displaying device.

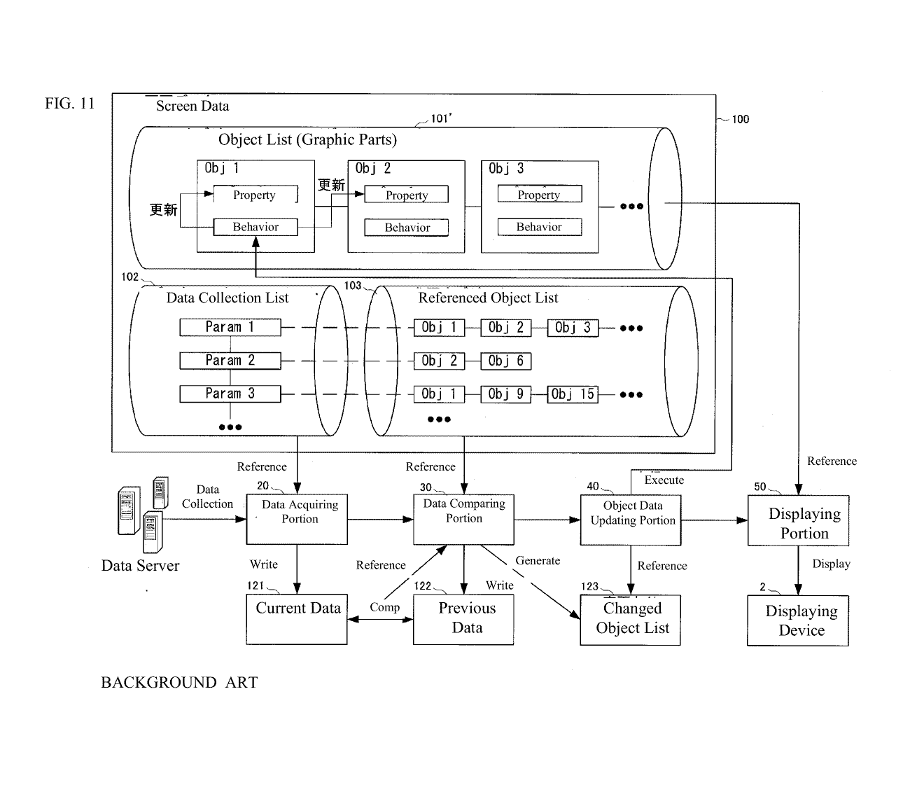

FIG. 12 is a flowchart for explaining the operation of the conventional monitoring subject displaying device.

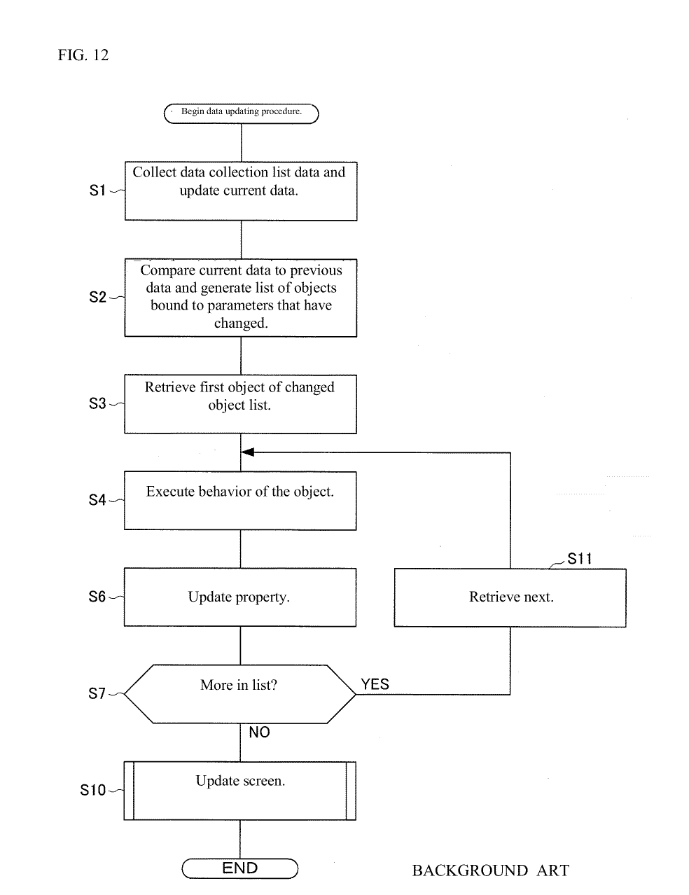

### DETAILED DESCRIPTION

An example according to the present invention will be explained below in reference to the drawings.

### Structure of the DCS

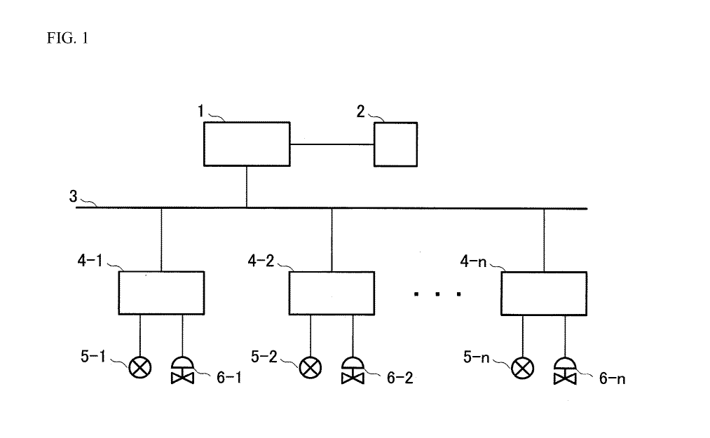

FIG. 1 displays an overview of a DCS (Distributed Control System) that includes a monitoring subject displaying device according to the present example.

A plurality of controllers 4-1 though 4-n that are connected to a network 3 is connected to respective sensors 5-1 though 5-n and actuators 6-1 though 6-n that are provided within a plant, or the like, to control the actuators 6-1 though 6-n in accordance with the values of the respective sensors 5-1 though 5-n.

The monitoring subject displaying device 1 according to the present example is structured from a displaying device 2, such as a liquid crystal displaying device (LCD), or the like, and a DCS human-machine interface (HMI). This monitoring subject displaying device 1 communicates with the plurality of controllers 4-1 though 4-n through the network 3, to monitor the status of the plant, that is, the outputs of the sensors 5-1 though 5-n and the process variables of the actuators 6-1 though 6-n, and the like. Moreover, the monitoring subject displaying device 1 uses a display screen that has been prepared in advance to display graphically, on the displaying device 2, the values of the parameters that indicate the status of the plant, acquired through the network 3.

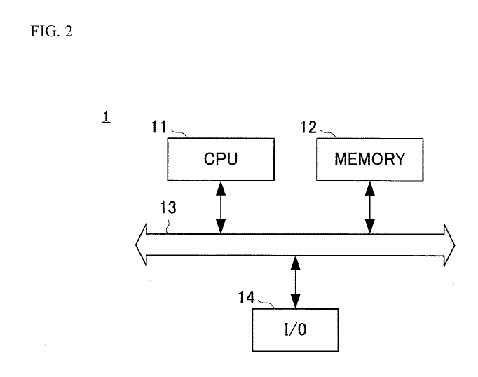

As illustrated in FIG. 2, in terms of hardware, the monitoring subject displaying device 1 is a computer that includes a central processing device (CPU) 11, a storing device (MEMORY) 12, various types of input/output devices (I/O) 14, and a bus 13 able to connect these to each other so as to enable communication. This operates as a monitoring subject displaying device, as described below, through a computer program that is installed in the storing device 12.

### Display Screen and Method for Generating the Same

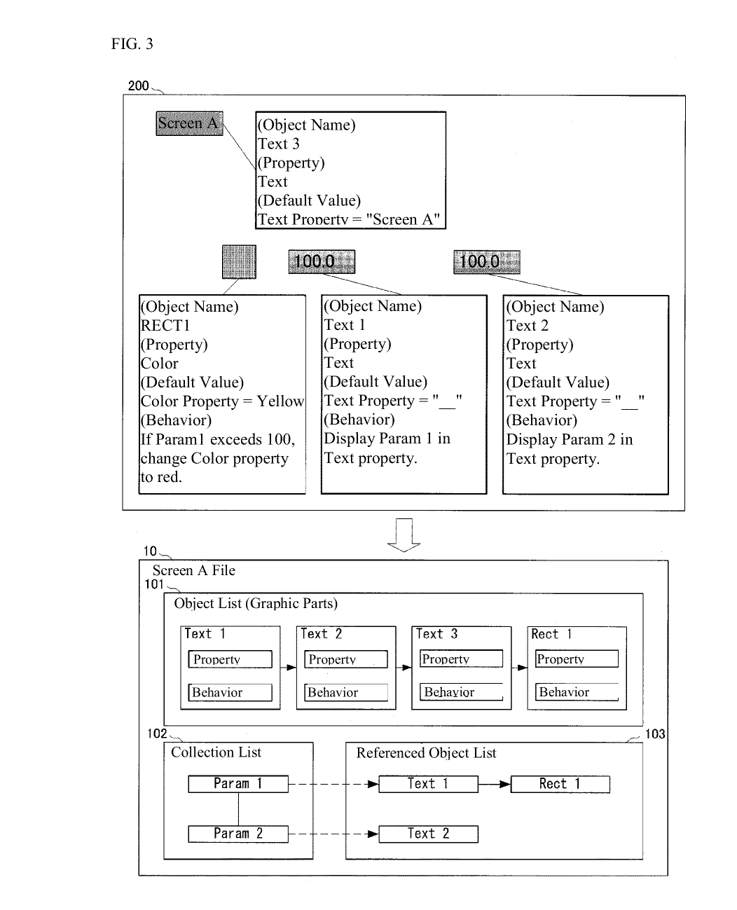

The display screen of the monitoring subject displaying device 1 will be explained next. The display screen in the monitoring subject displaying device according to the present example is that which provides visualization through text display or graphic display of process data, such as measured values for the monitoring subject, setting values, and the like. Such a display screen is generated using an application for editing. As described above, the editing application is prepared with graphic parts (objects) such as, for example, a text object for displaying a character string, a bar object for displaying a bar graph, and the like. The user uses the editing application to generate a display screen that will be the HMI through laying out, in arbitrary positions of the editing screen 200, the graphic parts (hereinafter termed “objects”) corresponding to monitoring subjects, as illustrated in FIG. 3.

As illustrated in FIG. 3, objects have respective unique names (object names) and properties. Properties define the status of the object. In the case of a text object, as the status of the object there are the properties that are required for displaying the object, such as, for example, the text, the text color, the text size, and the like. A user places the graphic parts (objects) that correspond to the monitoring subjects at arbitrary locations on the editing screen, and those objects can be displayed as a static image if the default values of the properties are set.

For example, in FIG. 3, as the parts that structure a single screen A, objects having the object names “Rect1”, “Text1”, “Text2”, and “Text3” on the editing screen 200, and these objects have, as the default values for their properties, respectively “Yellow”, “_”, “_”, and “Screen A”.

Moreover, the user is able to set “behaviors” that describe the relationships between parameters and properties that are bound to the objects, to display, as animated images wherein the display of the object changes in accordance with changes of the value of a parameter (for example, a measured value) of the monitoring subject.

This type of “behavior” is that which defines, through a script, or the like, the binding between a parameter and an object, and how the value of an object will change in response to a change in a parameter, such as a measured value, that is, the relationship between the value of the parameter that is bound to the object and the property of the object.

For example, FIG. 3 shows that, for example, for the object with the object name “Rect1,” the “behavior” is defined as “If the parameter Param1 exceeds 100, then the Color property is changed to red.”

Note that when the value of a property is to be updated in the monitoring subject displaying device 1 according to the present example, the “behavior” of the object is sent to a property updating portion 60, described below, in combination with the object name of the object, the property name of the property to be updated, and the value of the property to be updated.

The user, in each individual screen, is able to perform editing such as laying out the objects, setting the default values of the properties, and defining the behaviors, to generate a display screen that will serve as the HMI. The application for editing generates, for each screen, screen data 10 that includes an object list 101, a data collection list 102, and a referenced object list 103, from the display screen that is generated in this way, and stores these as a screen file on a storing device such as a hard disk drive (HDD). The object list 101 is a list of objects that structure a single screen (for example, Screen A), where each object includes the properties that describe the status of the object and the behavior for calculating the values of the properties based on the values of the parameters of the monitoring subjects.

Moreover, the data collection list 102 is a list of the parameters that are referenced within the screen, that is, a list of the parameters for which the parameters that are bound to the objects that are displayed in the screen display are extracted and data thereof is collected. If within a given screen the same parameter is bound to a plurality of objects, then those elements that are listed redundantly are deleted.

Moreover, the referenced object list 103 is a list, for each parameter, of the objects that reference that parameter. Typically, a parameter that is an element in the data collection list is bound to a plurality of objects. This referenced object list 103 includes referencing relationships between objects that are stored in the object list 101, in addition to referencing relationships between objects that are stored in the object list 101 and parameters that are stored in the data collection list 102.

### Example Configuration of Display Screen

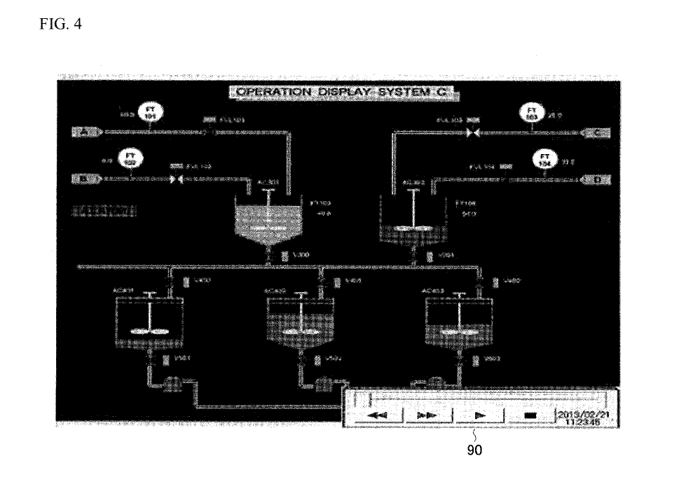

FIG. 4 illustrates an example of a display screen, displayed on the displaying device 2. On this screen, the instruments that structure the plant are displayed graphically, along with the values outputted by the various sensors and the setting values for the actuators.

Moreover, a display control player 90 is displayed in a portion of the display screen. The display control player 90 is one object that structures the display screen. In the present example, the display control player 90 is provided with a rewind button, a play button, a fast-forward button, and a control bar, enabling the user to change the display of the screen from the current status to displaying a status from the past. Moreover, a portion of the display control player 90 may be structured so as to display the time of the display of the monitoring subjects that are displayed on the display screen, that is, so as to display the time at which the values of the properties of the individual objects were updated. In the present example, such a display control player 90 is displayed on the screen of the displaying device 2 in parallel with a screen that displays the monitoring subjects graphically, and through receiving a user operation can switch from a current mode, which displays the current status of the monitoring subjects, to a historic mode, which displays historic statuses, and to specify a range for playing back the screen.

### Structure of the Monitoring Subject Displaying Device

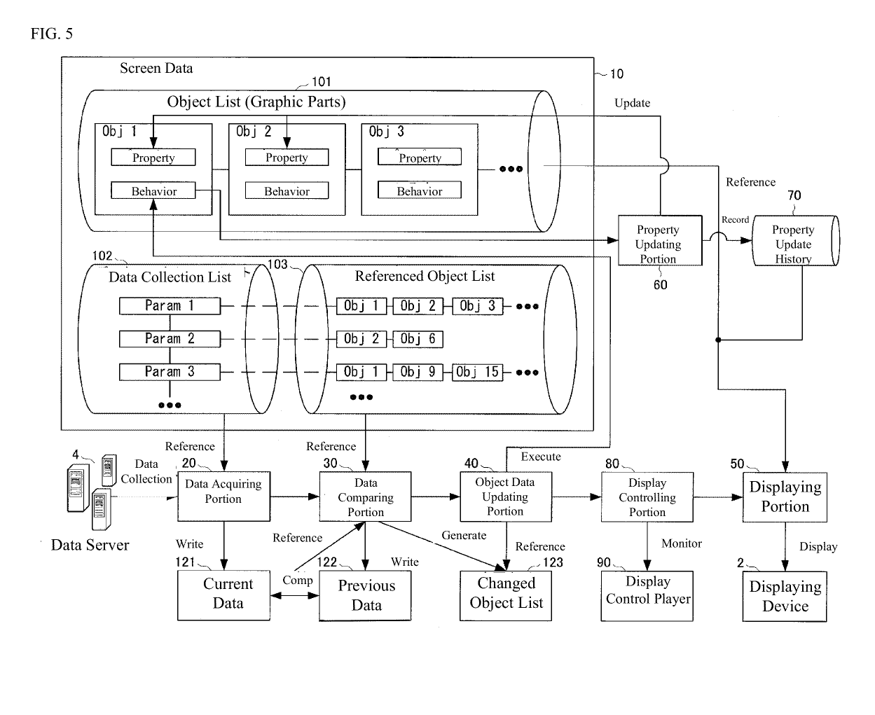

The structure of the monitoring subject displaying device according to the present example will be explained next in reference to FIG. 5.

As illustrated in FIG. 5, the monitoring subject displaying device is provided with: screen data 10 wherein the aforementioned screen file is loaded in a storing device 12; a property updating portion 60 for updating the value of a property of an object that is stored in this screen data 10 to a value that is calculated in accordance with a “behavior”; a property update history storing portion 70 for storing a history of updating of properties by the property updating portion 60; and a displaying portion 50 for displaying, on the displaying device 2, objects that are stored in the object storing portion 10 using historic values for the properties, stored in the property update history storing portion 70.

Here the screen data 10 that is loaded in the storing device 12, through having the object list 101, operates as an object storing portion for storing an object that includes properties that describe the status of the object that is defined as corresponding to the monitoring subject, and a behavior for calculating the value of a property based on the value of a parameter of the monitoring subject.

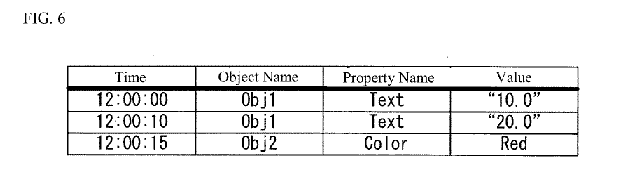

Moreover, as illustrated in FIG. 6, the property update history storing portion 70 is a table for storing the times at which property values were changed, and the values of the properties that were changed, in relation to each other. In the property update history table example that is illustrated in FIG. 6, a single record is structured through a time at which a property value was updated, along with the object name, property name, and the value for which the value of the property was updated at that time, in relation to each other. Hereafter, these records shall be termed “property update records.”

The monitoring subject displaying device 1 according to the present example further includes a data acquiring portion 20 for collecting monitoring subject data; a data comparing portion 30 for detecting whether or not there has been a change in a value of a parameter; and an object data updating portion 40 for applying, to an object that is bound to a parameter wherein a value has changed, the value of the parameter that has been changed.

Moreover, the monitoring subject displaying device 1 according to the present example includes a display controlling portion 80 for monitoring the display control player 90 (referencing FIG. 4) that is displayed on the display screen, to detect a user operation on the display control player 90, to switch between the “Current Mode,” which displays the current statuses of the monitoring subjects using the current values of the properties, and the “Historic Mode,” for displaying historic statuses of the monitoring subjects using historic values of the properties, stored in the property update history storing portion 70.

### Operation of the Monitoring Subject Displaying Device

The operation of the monitoring subject displaying device will be explained next in reference to FIG. 5 through FIG. 10.

The monitoring subject displaying device 1, at run-time, loads the aforementioned screen file into the storing device 12, and arranges each of the objects of the object list 101 on the screen using the default values of the properties.

### Property Value Update History Record

In the monitoring subject displaying device 1 according to the present example, in the “Current Mode,” the various objects are displayed using the current values for the properties thereof, while, on the other hand, the update history for the property values are recorded in the property update history storing portion 70.

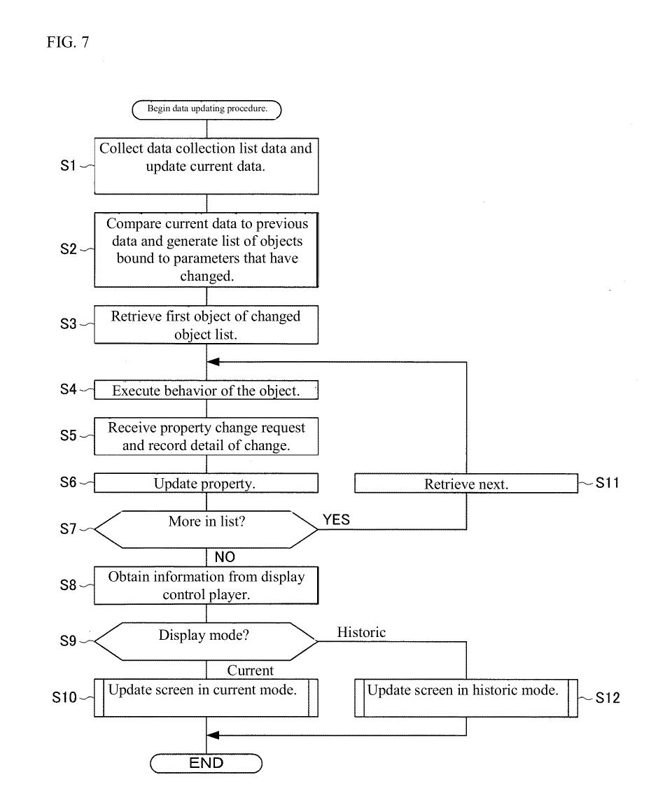

First, the data acquiring portion 20 references the data collection list 102 from a data server 4, or the like, to collect data, for a specific period, for the values of the parameters that are bound to the objects that structure the display screen, and update the values in a prescribed region 121 of the storing device 12 for storing the current values (the correct data) of the parameters that are bound to the objects that structure the display screen (FIG. 7: S1).

When a new value for a parameter has been written to the prescribed region 121, the data comparing portion 30 writes, to another prescribed region 122 of the storing device 12, the value that was previously written (the previous data), and compares the current data to the previous data, to detect whether or not there has been a change in a parameter value. The data comparing portion 30 references the referenced object list 103, to generate a list of objects that are bound to the parameter in which there has been the change in the value (a changed object list) 123, and stores it in a prescribed region (S2).

The object data updating portion 40 references the changed object list 123, which is a list of the objects that are bound to the parameter in which there was the change in value, and retrieves the first object on the list (S3), and applies the new value, to which the parameter has been changed, to the object that is bound to the parameter for which the value has changed. For the object for which the new value for the parameter has been applied, the “behavior” is executed (S4), to calculate a property value based on the new value.

When a new value for the property has been calculated based on the new value for the parameter that has been changed, the “behavior” of the object is sent to the property updating portion 60, described below, in combination with the object name of the object, the property in the name of the property to be updated, and the value to which the property is to be updated.

The property updating portion 60 receives the combination of the object name, the property name of the property to be updated, and the value to which the property is to be updated, and, along with recording them, together with the time of the update, and the like, in the property update history storing portion 70 (S5), updates the value of the property of the object that is stored in the object list 101, specified by the object name and property name (S6).

In this way, in contrast to the conventional technology wherein the value of the property of each object was changed directly, through the behavior, instead, in the monitoring subject displaying device 1 according to the present example, the value of the property is changed indirectly through the property updating portion 60, at which time the property updating portion 60 leaves a record of the updated detail in the property update history storing portion 70.

The changed object list 123 is referenced again, and if there is an object that is still to be processed in the changed object list 123 (S7: YES), then the next object is retrieved (S11), the behavior of that object is executed (S4), the value of the property is recorded in the update history (S5), and the value of the property of the object is updated (S6), where these steps are repeated for all objects that are included in the changed object list 123.

Once the behavior has been executed (S4), the update history has been recorded for the value of the property (S5), and the value of the property has been updated (S6), as described above, for all of the objects on the changed object list 123 (S7: NO), then the display controlling portion 80 acquires information from the display control player 90 (S8), and informs the displaying portion 50 as to which display mode, either the current mode or the historic mode, is indicated (S9). The displaying portion 50 updates the display screen by switching, depending on the display mode that has been indicated, between the current values from the object list 101, or the historic values that are stored in the property update history storing portion 70, for the source for referencing the properties of the various objects (S10 and S12).

### Operation of the Monitoring Subject Displaying Device (Part 1): Current Mode

When the display mode that is indicated by the display controlling portion 80 is the current mode, the displaying portion 50 references the object list 101 to display a display screen on the displaying device 2 in accordance with the values of the properties of the objects stored in the object list 101.

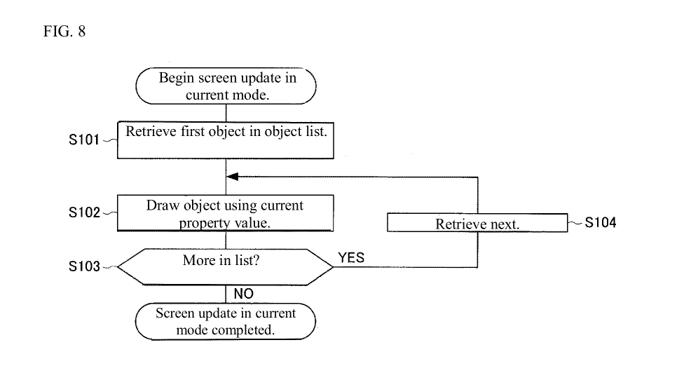

Specifically, as illustrated in FIG. 8, the displaying portion 50 first retrieves the first object in the object list 101 (S101), and draws the object using the current property values (S102). Thereafter, it references the object list 101 again, and if there is an object that is yet to be processed (S103: YES), retrieves the next object (S104), and draws the object using the current property values (S102). If drawing has been completed for all objects in the object list 101 (S103: NO), then the screen updating procedure in the current mode is terminated.

### Operation of the Monitoring Subject Displaying Device (Part 2): Historic Mode

If the display mode is the historic mode, then the displaying portion 50 references the object list 101 and the property change history storing portion 70 to display a display screen, on the displaying device 2, for the objects in the object list 101 in accordance with the object property values stored in the property change history storing portion 70.

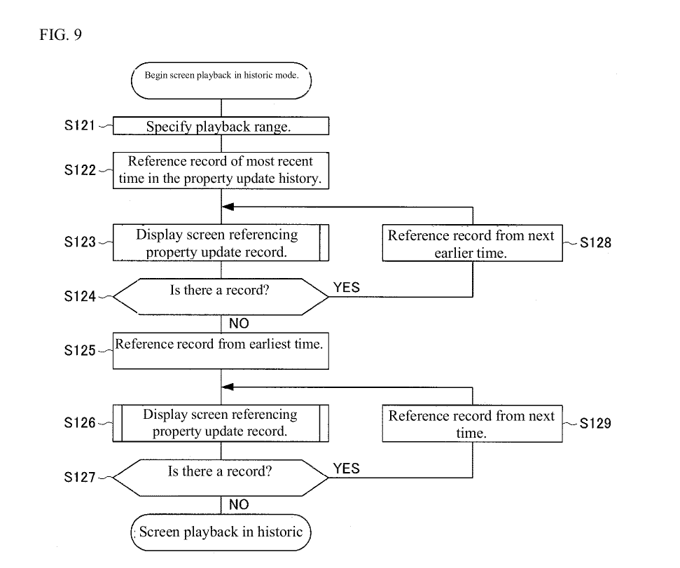

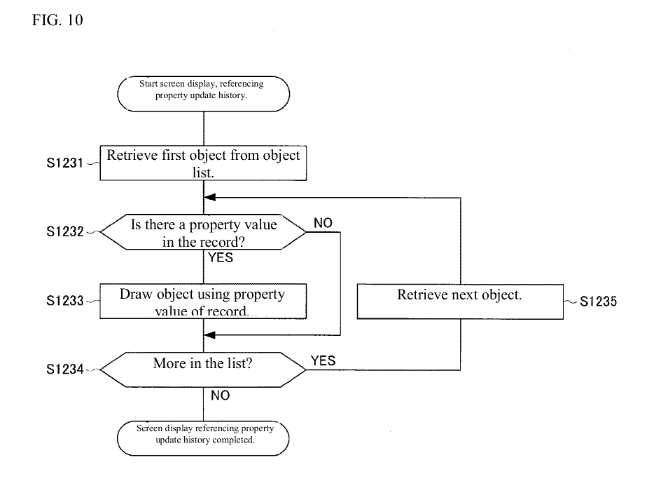

In the monitoring subject displaying device 1 according to the present example, when the historic mode is selected, then, in accordance with a user operation on the display control player 90, the statuses of the monitoring subject can be displayed sequentially backwards from a display based on the current property values to a display based on the historic property values specified by the user, or the changes from the historic display up until the current time can be played back on the screen, through the procedures shown in FIG. 9 and FIG. 10.

First, a playback range is specified through a user operating the display control player 90 (S121). When the playback range has been specified, the display controlling portion 80 reports, to the displaying portion 50, the playback range, and provides an instruction to perform screen updating in the historic mode. The displaying portion 50, which has been notified to perform screen updating in the historic mode, references the object list 101 and the most recent property update record of the property update history storing portion 70, to perform a screen display referencing this property update record (S123).

As illustrated in FIG. 10, in the screen display that references the property update record, the displaying portion 50 first extracts the first object from the object list 101 (S1231), and if there is an object property value in the referenced property update record (S1232: YES), draws the object using the property value that is recorded in the property update record (S1233). Conversely, if, in the referenced property update record, there is no property value for the object extracted from the object list 101, then the displaying portion 50 leaves the display as it is, without redrawing that object.

Given this, if there is an object in the object list 101 that is yet to be processed (S1234: YES), then the next object is extracted (S1235), and the object is drawn using the value of the property as recorded in the referenced property update record (S1232 and S1233), and if the procedure has been performed based on the referenced property update record for all objects in the object list 101 (S1234: NO), then the screen display based on the referenced property update record is complete.

As described above, when the screen display referencing the property update record from the most recent time (S123) has been completed, then if there is another property update record within the playback range, specified by the user (S124: YES), then the property update record from the next earlier time is referenced, to perform the screen display referencing that property update record, as described above. In this way, the monitoring subject can be displayed in reverse order from a display based on the current property values to a display based on historic property values, as specified by the user.

When the display based on all property update records included in the playback range specified by the user has been completed (S124: NO), then the displaying portion 50 performs the screen display referencing each property update record, from the property update record from the oldest point in time, sequentially toward the present (S125, S126, S127, and S129). This procedure enables the user to playback historic display screens in a specified range.

### Monitoring Subject Displaying Device according to the Present Example

The monitoring subject displaying device and displaying method according to the present example focuses on the point that that which is directly relevant to updating a display screen is a change in a property of an object, and stores the information required for playing back historic statuses by recording the change history of the properties in a property change history storing portion 70. The displaying portion 50 draws objects referencing the values for the properties as stored in the property change history storing portion 70 to display historic statuses, and thus the amount of data recorded is small when compared to the normal video recording.

Moreover, while a conventional monitoring subject displaying device has a function for collecting a history of process data, reflecting this process data history into the display on the screen requires passing through the “behavior” of each individual object, and so even if the values of the parameters in the data collection list are identical, the screen displays are not necessarily identical. In contrast, in the monitoring subject displaying device and displaying method according to the present example, the data that is directly relevant to the screen display, that is, the history of the property values, is recorded, making it possible to return to the screen status 21 from the past.

Moreover, a display control player 90 having a Rewind button and a Play button is displayed on the display screen together with the screen displayed above, enabling a user who wishes to re-create a historic display to perform an operation to display screen displays from the current status to display a historic status.

The present invention can be used in a display screen that uses objects, such as a DCS HMI.

1. A monitoring subject displaying device comprising:
a storing portion that stores an object, being an object for which a correspondence to the monitoring subject is defined, including a property that describes a status of the object, and a behavior for calculating a value for the property based on a value of a parameter of the monitoring subject;
a property updating portion that updates, to the value calculated in accordance with the behavior, the value of the property of the object stored in the object storing portion;
a property update history storing portion that stores a history of property updating by the property updating portion; and
a displaying portion that displays, on a displaying device, the object that is stored in the object storing portion, using a historic value for the property, stored in the property update history storing portion.

2. The monitoring subject displaying device as set forth in claim 1, wherein:
the property update history storing portion is a property update history table for storing a time at which a value of a property was changed, and the value to which the property was changed, in relation to each other.

3. The monitoring subject displaying device as set forth in claim 1, further comprising:
a display controlling portion that switches between a current mode for displaying the object using a current value for the property, and a historic mode for displaying the object using a historic value for the property, stored in the property update history storing portion; wherein:
the displaying portion, in the current mode, displays the object on the displaying device using the current value for the property, and in the historic mode, displays the object on the displaying device using a historic value for the property, stored in the property update history storing portion.

4. The monitoring subject displaying device as set forth in claim 1, wherein:
when a plurality of historic values for the property, stored in the property update history storing portion, form a time series, the object is displayed sequentially on the displaying device using historic values following the time series.

5. A monitoring subject displaying method comprising:
a step for storing, in a storing portion, an object, being an object for which a correspondence to the monitoring subject is defined, including a property that describes a status of the object, and a behavior for calculating a value for the property based on a value of a parameter of the monitoring subject;
a step wherein a property updating portion updates, to the value calculated in accordance with the behavior, the value of the property of the object stored in the object storing portion;
a step for recording, in a property update history storing portion, a history of property updating by the property updating portion; and
a step wherein a displaying portion displays, on a displaying device, the object that is stored in the object storing portion, using a historic value for the property, stored in the property update history storing portion.

6. A non-transitory computer-readable medium embodying a computer program for causing a computer to function as a monitoring subject displaying device that comprises:
a storing portion that stores an object, being an object for which a correspondence to the monitoring subject is defined, including a property that describes a status of the object, and a behavior for calculating a value for the property based on a value of a parameter of the monitoring subject;
a property updating portion that updates, to the value calculated in accordance with the behavior, the value of the property of the object stored in the object storing portion;
a property update history storing portion that stores a history of property updating by the property updating portion; and
a displaying portion that displays, on a displaying device, the object that is stored in the object storing portion, using a historic value for the property, stored in the property update history storing portion.
